(19) United States
(12) Patent Application Publication
(10) Pub. No.: US 2009/0309043 A1
(43) Pub. Date: Dec. 17, 2009

(54) CHARGED PARTICLE BEAM APPARATUS AND SAMPLE HOLDING SYSTEM

(75) Inventors: Takashi NOBUHARA, Hitachinaka (JP); Shouji Tomida, Hitachinaka (JP); Hajime Shimada, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/472,072

(22) Filed: May 26, 2009

(30) Foreign Application Priority Data
Jun. 17, 2008 (JP) 2008-157331

(51) Int. Cl. G21K 5/10; G01N 23/00

(52) U.S. Cl. 250/442.11; 250/306

(57) ABSTRACT

An object of the present invention is to obtain a charged particle beam apparatus that includes a simplified sample positioning mechanism used with an electrostatic chuck, allow the sample to be released easily when residual attraction occurs, and enable observation throughout an entire area on an outer peripheral portion of the sample. To attain the object, the present invention provides a charged particle beam apparatus including, in a sample holding system for holding a sample, an outer peripheral part for holding the sample at the outer peripheral portion on a backside of the sample and raising and lowering the sample; a drive portion for raising and lowering the outer peripheral part; an electrostatic chuck for attracting the backside of the sample; and a part for correcting an electric field that is of substantially the same height as the peripheral portion of the sample when the sample is attracted onto the electrostatic chuck.

### FIELD OF THE INVENTION

The present invention relates to a sample holding system used in a charged particle beam apparatus such as a scanning electron microscope and a method for holding and releasing a sample.

### BACKGROUND OF THE INVENTION

Lately, integration of semiconductor products has been greatly improved and there has been a mounting need for even higher definition of circuit patterns in the semiconductor products. Inspection means of various types are being used for the quality control and improved yield in samples on which circuit patterns are formed, typically, semiconductor wafers. Known as applications of a scanning electron microscope, or SEM, in inspection are, for example, a measuring SEM that measures dimensional accuracy of the circuit patterns and a defect review SEM that evaluates the circuit patterns in terms of defect or deposited foreign matter. In these SEMs, the sample is irradiated with an electron beam which is one type of a charged particle beam to achieve the foregoing purposes.

In observing the sample, for example, a semiconductor wafer, using the charged particle beam, changes in an electric field distribution in areas around an outer peripheral portion of the sample result in degraded image quality, as represented by a distorted or defocused observed image of the areas of the outer peripheral portion of the sample. This phenomenon leads to various kinds of problems, including an error in a measured dimension value, erroneous detection of a defect, and inability to capture a clear image. As a means of solving the foregoing problem, a method is proposed for controlling and equalizing the electric field around the outer peripheral portion by adding an annular conductive element to which voltage can be applied to sample holding means around the outer peripheral portion of the sample (see, for example, JP-A-2004-235149). As another means, a method is proposed for slacking the electric field distribution by narrowing the gap in height conventionally noted between the outer peripheral portion and the sample holding means. This is achieved by surrounding the sample with a sample positioning part that is substantially equal in height to the sample (see, for example, JP-A-2004-079516).

The condition in which the sample is held in place greatly affects the image observed. A known method as an example of a mechanical holder of the sample uses two reference pins disposed on an outer periphery of the sample; a movable pin is then made to exert a pressure to hold the sample in place from an opposing direction. In this method, when the sample pressure is increased, the holding force increases so that deviation of the sample caused by vibration can be reduced; on the other hand, the increased holding force distorts the sample, which makes difficult the observation of the sample with high accuracy. The wafer is thin and a single piece of it offers good parallelism with poor flatness on a bench. As a result, the sample tends to be held in a concave or convex form. In such conditions, movement of the sample involves fluctuations in its height of a maximum of about 100 μm. This necessitates setting of a large focal depth or focus movable distance of an electron optics system. This imposes great restrictions on the design of electron lenses and it becomes difficult to increase resolution for the improved image quality. Using an electrostatic chuck for the sample holding means achieves both flattening of the sample surface and a greater holding force.

### SUMMARY OF THE INVENTION

When an outer peripheral part is used to position the sample on the electrostatic chuck in a sample holding system, movement of the sample on the electrostatic chuck causes the sample to rub against the electrostatic chuck, thus producing foreign matter. Or, the sample is attracted by the electrostatic chuck as affected by electrostatic charge, which disables positioning. As a sample positioning method used together with the electrostatic chuck, therefore, a possible method is to use a pusher pin that is independently operable to raise and lower the sample, so that the sample is positioned in a condition of not in contact with the electrostatic chuck. There are, however, a number of technical problems to be solved before those parts can be accommodated in a limited space inside a sample table. A still further problem is that no parts for correcting the electric field can be disposed at a position of the outer peripheral part, which disables observation of the image in areas around the outer peripheral part. In addition, if residual attraction occurs because of the electrostatic chuck, a phenomenon could result, in which a simple pusher pin is not simply effective in raising the sample off from the electrostatic chuck.

It is an object of the present invention to provide a charged particle beam apparatus, a sample holding system, and a method for holding and releasing a sample that include a simplified sample positioning mechanism used with an electrostatic chuck, allow the sample to be released easily when residual attraction occurs, and enable observation throughout an entire area on an outer peripheral portion of the sample.

To achieve the foregoing object, an aspect of the present invention provides a sample holding system for holding a sample in place. The sample holding system includes an outer peripheral part that holds the sample at an outer peripheral part on a backside thereof and raises and lowers the sample, a drive portion that raises and lowers the outer peripheral part, an electrostatic chuck that attracts the backside of the sample, and a part for correcting an electric field that is of substantially the same height as the peripheral portion of the sample when the sample is attracted onto the electrostatic chuck.

In accordance with the aspect of the present invention, the structure for holding the sample can be simplified, release of the sample can be made easily, and the image of the entire outer peripheral portion of the sample can be observed.

### BRIEF DESCRIPTION OF THE DRAWINGS

Other objects and advantages of the invention will become apparent from the following description of embodiments with reference to the accompanying drawings in which:

FIG. 1 is a longitudinal cross-sectional view showing a scanning electron microscope;

FIG. 2 is a plan view showing an arrangement of a sample holding system;

FIGS. 3A to 3F are cross-sectional views showing arrangements of the sample holding system; and

FIG. 4 is a cross-sectional view showing an arrangement of the sample holding system.

### DETAILED DESCRIPTION OF THE PREFERRED EMBODIMENTS

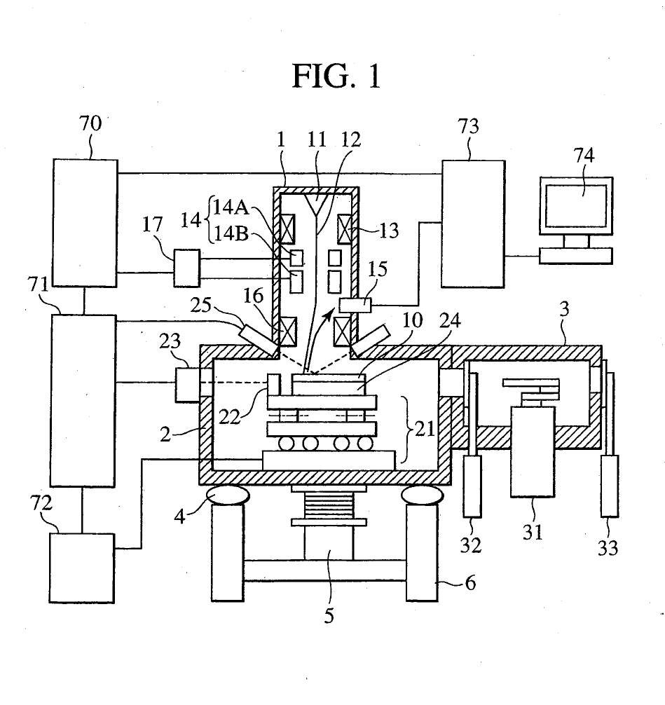

A preferred embodiment of the present invention will be described below using a scanning electron microscope as an example of a charged particle beam apparatus to which the present invention is applied and with reference to FIGS. 1 through 3. FIG. 1 is a longitudinal cross-sectional view showing the scanning electron microscope. A base 6 is set up on the floor and a mount 4 that isolates floor vibration is disposed on the base 6. Further, the mount 4 supports a sample chamber 2. The sample chamber 2 includes a column 1 and a load lock 3. The column 1 generates and controls an electron beam. The load lock 3 includes a transport robot 31 that transports samples. The sample chamber 2 is evacuated at all times by a vacuum pump 5. There is another vacuum pump not shown that maintains a high vacuum in the column 1. The load lock 3 further includes an atmosphere-side gate valve 33 and a vacuum-side gate valve 32. The atmosphere-side gate valve 33 isolates the load lock 3 from the atmosphere. The vacuum-side gate valve 32 isolates the load lock 3 from the sample chamber 2.

A sample transport path will be briefly described below. The atmosphere-side gate valve 33 is opened and a sample 10 is introduced into the load lock 3 from the atmosphere side using the transport robot 31. The atmosphere-side gate valve 33 is closed and the load lock 3 is evacuated with a vacuum pump not shown. When the degree of vacuum in the load lock 3 becomes equivalent to that in the sample chamber 2, the vacuum-side gate valve 32 is opened and the transport robot 31 transports the sample 10 onto a stage 21 included in the sample chamber 2. After having been processed, the sample 10 is transported through the load lock 3 and returned to the atmosphere by reversing the above-referenced flow. The sample 10 is electrostatically attracted by an electrostatic chuck 24 mounted on the stage 21 and rigidly held in place thereon.

The stage 21 includes a bar mirror 22 mounted thereon. The bar mirror 22 allows the position of the sample 10 on the stage 21 to be controlled through laser-based length measurement taken of changes in a relative distance from an interferometer 23 mounted on the sample chamber 2. Position information of the stage 21 is created by a position control unit 71 and then transmitted to a stage control unit 72 that drives the stage 21. The stage control unit 72 provides feedback control so as to eliminate any deviation between current position information and target coordinates. Possible types of the feedback control include control achieved through simple position feedback and PID control aimed at improved response speed and positioning accuracy by adding stage speed information and integral information of stage position deviation.

An electron beam 12 generated by an electron gun 11 inside the column 1 travels through an electron lens 13 that has a convergence action and an electron lens 16. The electron beam 12 is then deflected into a desired orbit by a deflector 14 before the sample 10 is irradiated with the electron beam 12. A reflected electron or a secondary electron generated by the irradiation of the electron beam 12 is detected by a detector 15 and transmitted to an image control unit 73 together with control information of the deflector 14. An image is generated based on the control information of the deflector 14 and the information from the detector 15 and is displayed as an image on a display 74.

An optical Z sensor 25 that detects height of the sample 10 is disposed upward of the sample chamber 2, so that the height of the sample 10 can be monitored at all times. The signal thereby obtained is converted to corresponding position data by the position control unit 71 and the position data is then transmitted to a column control unit 70. Based on this information, the column control unit 70 changes an optical condition of the electron lens 16 in order to ensure a correct focus even with varying heights of the sample 10.

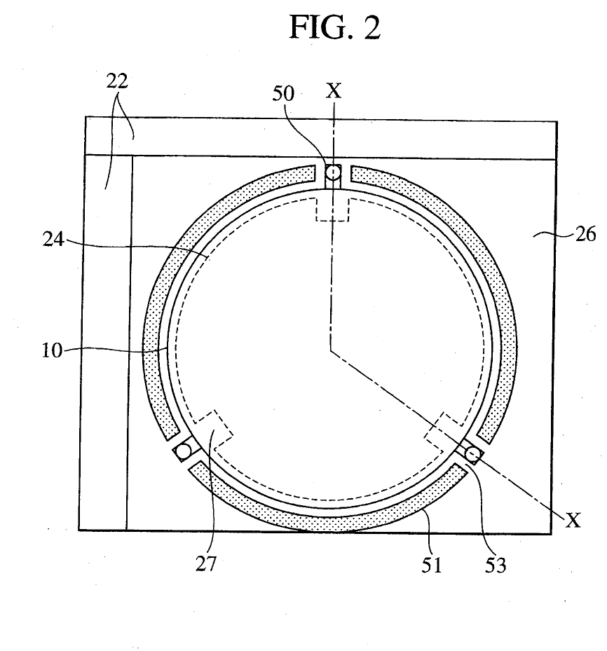

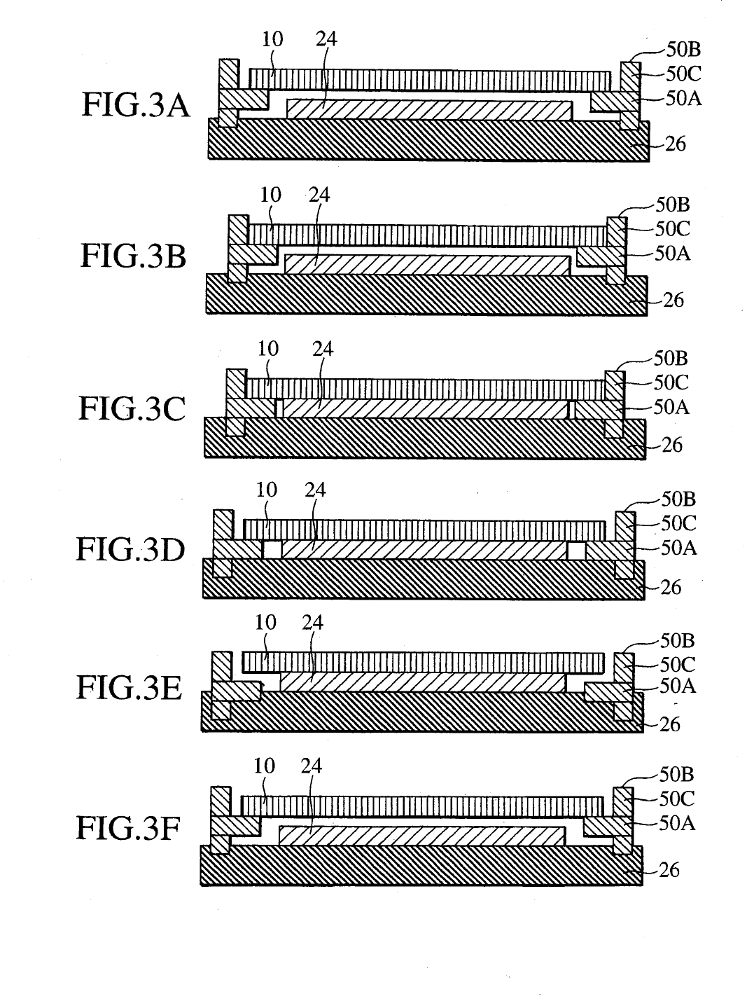

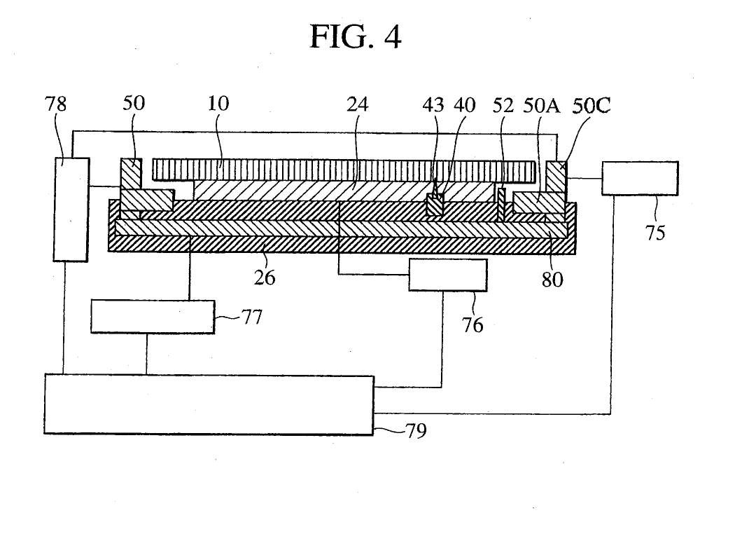

FIG. 2 is a plan view showing an arrangement of a sample holding system. FIGS. 3A to 3F, and 4 are cross-sectional views of the sample holding system. The electrostatic chuck 24 and an outer peripheral part 50 are disposed on a sample holder table 26 and the sample 10 is placed on the electrostatic chuck 24. There are three outer peripheral parts 50 which are supported by an outer peripheral part base 80. The outer peripheral part base 80 is driven vertically by a vertical movement drive source 77, which results in up-and-down motions of the outer peripheral parts 50. A horizontal movement drive source 78 is disposed to drive the outer peripheral part base 80 in horizontal direction. A pressure sensor detector 75 that determines a condition of attraction by the electrostatic chuck 24 is disposed at least one of the outer peripheral parts 50.

An electrostatic chuck power source 76 supplies the electrostatic chuck 24 with voltage. A main control unit 79 controls the drive of the outer peripheral parts 50 and the electrostatic chuck power source 76. A signal from the pressure sensor detector 75 is fed back to the electrostatic chuck power source 76 and for the drive of the outer peripheral parts 50 via the main control unit 79. The electrostatic chuck 24 includes cutouts 27 to prevent the electrostatic chuck 24 from interfering with the outer peripheral parts 50 that move horizontally. Having cutouts 27 radially deeper toward the center allows the outer peripheral parts 50 to position even a sample having a small diameter. As a result, a single electrostatic chuck 24 is adaptable to varying sample diameters.

When a sample is observed by irradiating the sample with charged particles, the surface of the sample is charged, resulting in a defocused or distorted image. As a preventive measure for this phenomenon, the sample 10 includes a ground protrusion 40 disposed on a backside thereof. Through attraction, the ground protrusion 40 contacts a ground mechanism 43 mounted on the sample holder table 26. Any charge in the sample 10 is thereby neutralized. Note herein that grounding means to ground the sample 10 to a voltage level at which the sample 10 should be and does not mean to let zero volts develop in the sample 10. The ground mechanism 43 has a contact portion that is shaped like a needle-like protrusion or a knife edge. The ground mechanism 43 is kept pressing against the sample 10 with a fixed force by a pressure spring not shown. The ground mechanism 43 helps make the sample 10 less easy to charge, permitting observation of the image with good image quality for an extended period of time.

An annular part for correcting an electric field 51 is disposed around the sample 10. The part for correcting an electric field 51 is set so as to be substantially as high as a peripheral portion of the sample 10 when the sample 10 is attracted onto the electrostatic chuck 24. The part for correcting an electric field 51 moves a change in the electric field at an end portion of the sample 10 to an outer peripheral end portion of the part for correcting an electric field 51, thereby uniforming the electric field on the surface of the sample 10 up to the end portion. The image at the end portion of the sample 10 can thereby be prevented from being distorted. The part for correcting an electric field 51 includes slits 53 formed therein for preventing the part for correcting an electric field 51 from interfering with the outer peripheral parts 50. It is desirable that the ground protrusion 40 and the part for correcting an electric field 51 be on the same potential, so that the ground protrusion 40 and the part for correcting an electric field 51 are insulated from others and connected to each other using a jacketed cable.

Sample transport will be described below. FIGS. 3A through 3F show in sequence that the sample 10 is transported to a position over the electrostatic chuck 24, attracted thereonto, and released therefrom, using a cross-sectional view taken along line X-X of FIG. 2. FIGS. 3A to 3F correspond, respectively, to steps A through F in the flow of the sample 10 being transported, attracted, and released. Steps A through E represent the flow up to the attraction of the sample 10. In step A, the transport robot 31 shown in FIG. 1 transports the sample 10 onto a position above the electrostatic chuck 24 and the sample 10 is supported by outer peripheral part horizontal portions 50A. In according with the embodiment of the present invention, the horizontal portion 50A of the outer peripheral part 50 allows the sample 10 to be positioned without having any independent lifting mechanism. Preferably, a material that has as small friction as possible with the sample 10 to produce as little foreign matter as possible is used for the horizontal portion 50A. Possible effective materials include, for example, a resin that offers high wear resistance and emits only a small amount of gas in vacuum.

Referring to step B, the horizontal movement drive source 78 shown in FIG. 4 moves the outer peripheral part 50 horizontally and outer peripheral part taper portions 50C at three places clamp the sample 10 to position the sample 10. Stoppers 52 shown in FIG. 4 are disposed at two places along horizontal movement paths of two of three outer peripheral part taper portions 50C. This uniquely defines positions of the two outer peripheral part taper portions 50C, which, in turn, uniquely defines a position at which the sample 10 is fixed. To prevent the sample 10 from being clamped by the outer peripheral part taper portions 50C at three places before the two outer peripheral part taper portions 50C with the stoppers 52 contacting the stoppers 52, the rest of the outer peripheral part taper portion 50C without the stopper 52 is driven with a time lag relative to the two outer peripheral part taper portions 50C with the stoppers 52.

Referring to step C, the outer peripheral parts 50 lower, so that the sample 10 rests on the electrostatic chuck 24. The outer peripheral parts 50 can be raised and lowered by the outer peripheral part base 80 shown in FIG. 4 being driven vertically by the vertical movement drive source 77. Voltage is thereafter applied to the electrostatic chuck 24, which attracts the sample 10 onto the electrostatic chuck 24.

In step D, the outer peripheral parts 50 at three places are moved horizontally by the horizontal movement drive source 78 along the slits 53 in the part for correcting an electric field 51.

In step E, the vertical movement drive source 77 brings outer peripheral part flat portions 50B into flush with the part for correcting an electric field 51. This brings the sample 10 into flush with the surrounding height. Electric field distribution is then uniformed to eliminate image distortion, enabling observation of the image throughout the entire outer peripheral portion. The outer peripheral parts 50 are kept conductive with the part for correcting an electric field 51 through the sample holder table 26.

A flow, through which the sample 10 is released from the electrostatic chuck 24 and fed out of the electrostatic chuck 24, will be described below. In step F, after the voltage to the electrostatic chuck 24 is shut down, the outer peripheral parts 50 raise again to lift the sample 10. In accordance with the embodiment of the present invention, the sample 10 is released, not at the central portion thereof but at the outer peripheral portion thereof, from the electrostatic chuck 24. This allows the sample 10 to be released easily even if the sample 10 is attracted to the electrostatic chuck 24 through residual attraction.

If a strong residual attraction is involved, in which case the sample 10 cannot be released even from the outer peripheral portion thereof, forcing to lift the sample 10 could result in a damaged sample 10. As a countermeasure against this problem, the following procedure should be used to lift the sample 10.

During the sequence from steps E to F of FIG. 3, the outer peripheral part horizontal portion 50A is temporarily stopped on the backside of the sample 10 before raising the outer peripheral part horizontal portion 50A. A force that is the largest possible to raise the outer peripheral part horizontal portion 50A and not to fracture the sample 10 is measured in advance and a force smaller than this is used to raise the outer peripheral part horizontal portion 50A. The sample 10 not being lifted can be detected with a position sensor not shown that detects the outer peripheral part 50 or the sample 10. If the sample 10 is not lifted, that indicates that residual attraction exists. The outer peripheral part horizontal portion 50A is therefore lowered to leave the sample 10 and, using the electrostatic chuck power source 76 shown in FIG. 4, voltage of a polarity opposite that during attraction of the sample 10 is applied to the electrostatic chuck 24, so that any residual charge that causes the residual attraction to occur can be neutralized. Steps E to F are then carried out a second time.

Preferably, a pressure sensor not shown is disposed on a surface of the outer peripheral part horizontal portion 50A shown in FIG. 3 in contact with the sample 10. Using this pressure sensor, an attraction of the sample 10 is measured and the pressure data is transmitted from the pressure sensor detector 75 to the main control unit 79, so that the main control unit 79 can determine the voltage of the opposite polarity to be applied to the electrostatic chuck 24.

The force with which to raise the outer peripheral part horizontal portion 50A may be varied. During the steps from E to F of FIG. 3, the outer peripheral part horizontal portion 50A is temporarily stopped on the backside of the sample 10; the lifting force is then weakened and thereafter gradually increased to a maximum level at which the sample 10 is not fractured. The maximum limit force not to fracture the sample 10 should be set through measurement in advance. If the sample 10 is lifted during the process of increasing the lifting force, step F is continued. If the sample 10 cannot be lifted even when the maximum limit force not to fracture the sample 10 is reached, the outer peripheral part horizontal portion 50A is lowered to let the outer peripheral part horizontal portion 50A leave the sample 10; then, using the electrostatic chuck power source 76 shown in FIG. 4, voltage of the polarity opposite that during attraction of the sample 10 is applied to the electrostatic chuck 24, so that any residual charge that causes the residual attraction to occur can be neutralized. Steps E to F are then carried out a second time.

When the sample 10 is lifted by the outer peripheral parts 50, the transport robot 31 transports the sample 10 from the sample chamber 2 to the load lock 3. This completes observation of the sample 10.

As described heretofore, according to the embodiment of the present invention, a charged particle beam apparatus, a sample holding system, and a method for holding and releasing a sample can be provided that include a simplified sample positioning mechanism used with an electrostatic chuck, allow the sample to be released easily when residual attraction occurs, and enable observation throughout an entire area on an outer peripheral portion of the sample.

Aspects of the present invention are summarized as follows.

(1) A charged particle beam apparatus that permits observation of a sample by irradiating the sample with a charged particle beam to capture an image, the charged particle beam apparatus comprising:

an electron-optical column for generating the charged particle beam and irradiating the sample with the charged particle beam by focusing the beam to a narrow beam with an electron lens;

an image control unit for detecting a secondary signal generated from the sample as a result of the sample being irradiated with the charged particle beam and imaging the secondary signal for an visual image shown on a display;

a sample chamber including a built-in stage for positioning the sample relative to the charged particle beam;

a transport robot for transporting the sample to the sample chamber; and

a sample holding system for holding the sample disposed on the stage; wherein

the sample holding system includes

an outer peripheral part for holding the sample at an outer peripheral part on a backside thereof and raising and lowering the sample,

a drive portion for raising and lowering the outer peripheral part,

an electrostatic chuck for attracting the backside of the sample, and

a part for correcting an electric field that is of substantially the same height as a peripheral portion of the sample when the sample is attracted onto the electrostatic chuck.

(2) A sample holding system for holding a sample, comprising:

an outer peripheral part for holding the sample at an outer peripheral part on a backside thereof and raising and lowering the sample;

a drive portion for raising and lowering the outer peripheral part;

an electrostatic chuck for attracting the backside of the sample; and

a part for correcting an electric field that is of substantially the same height as the peripheral portion of the sample when the sample is attracted onto the electrostatic chuck.

(3) A sample holding system for holding a sample, comprising:

an electrostatic chuck for attracting the sample through an electrostatic force;

at least three outer peripheral parts disposed on an outer peripheral portion of the sample, the outer peripheral parts for holding the sample at an outer peripheral portion on a backside of the sample;

a vertical movement drive source for raising and lowering the outer peripheral parts;

a horizontal movement drive source for horizontally moving at least one of the outer peripheral parts;

a part for correcting an electric field disposed on the outer peripheral portion of the sample; and

a control unit for controlling vertical and horizontal movements of the outer peripheral parts; wherein

the electrostatic chuck includes cutouts for preventing the electrostatic chuck from interfering with the outer peripheral parts that move horizontally.

(4) The sample holding system according to the item 3, wherein

the peripheral portion of the sample is substantially as high as the part for correcting an electric field when the sample is attracted onto the electrostatic chuck.

(5) The sample holding system according to the item 3, wherein

a peripheral portion of the sample is substantially as high as the outer peripheral parts when the sample is attracted onto the electrostatic chuck.

(6) The sample holding system according to the item 3, wherein

the part for correcting an electric field includes slits formed therein for preventing the part for correcting an electric field from interfering with the outer peripheral parts.

(7) A method for holding a sample, the method comprising the steps of:

placing a backside of an outer peripheral portion of a sample on horizontal surfaces of at least three outer peripheral parts;

moving at least one of the three outer peripheral parts horizontally to bring the sample into abutment with vertical surfaces of the remaining outer peripheral parts;

lowering the horizontal surfaces of the outer peripheral parts to place the sample on an electrostatic chuck; applying voltage to the electrostatic chuck to fix the sample in place; and

moving the outer peripheral parts such that the outer peripheral parts are substantially as high as the sample.

(8) A method for releasing a sample, the method comprising the steps of:

placing a backside of an outer peripheral portion of a sample on horizontal surfaces of at least three outer peripheral parts;

moving at least one of the three outer peripheral parts horizontally to bring the sample into abutment with vertical surfaces of the remaining outer peripheral parts;

lowering the horizontal surfaces of the outer peripheral parts to place the sample on an electrostatic chuck; letting the horizontal surfaces of the outer peripheral parts leave the sample;

applying voltage to the electrostatic chuck to fix the sample in place;

shutting down the voltage applied to the electrostatic chuck, raising at least one of the outer peripheral parts, and, when the sample abuts on the horizontal surfaces of the outer peripheral parts, detecting a condition of attraction of the sample relative to the electrostatic chuck; and

raising the horizontal surfaces of the outer peripheral parts if the raising of the outer peripheral parts can avoid fracture of the sample.

(9) The method for releasing the sample according to the item 8 further comprising the step of:

if the raising of the outer peripheral parts can fracture the sample, halting the raising of the outer peripheral parts and applying voltage of a polarity opposite the voltage applied to the electrostatic chuck; and detecting a condition of attraction of the sample relative to the electrostatic chuck.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A charged particle beam apparatus that permits observation of a sample by irradiating the sample with a charged particle beam to capture an image, the charged particle beam apparatus comprising:
an electron-optical column for generating the charged particle beam and irradiating the sample with the charged particle beam by focusing the beam to a narrow beam with an electron lens;
an image control unit for detecting a secondary signal generated from the sample as a result of the sample being irradiated with the charged particle beam and imaging the secondary signal for an visual image shown on a display;
a sample chamber including a built-in stage for positioning the sample relative to the charged particle beam;
a transport robot for transporting the sample to the sample chamber; and
a sample holding system for holding the sample disposed on the stage; wherein
the sample holding system includes:
an outer peripheral part for holding the sample at an outer peripheral part on a backside thereof and raising and lowering the sample;
a drive portion for raising and lowering the outer peripheral part;
an electrostatic chuck for attracting the backside of the sample; and
a part for correcting an electric field that is of substantially the same height as a peripheral portion of the sample when the sample is attracted onto the electrostatic chuck.

2. A sample holding system for holding a sample, comprising:
an outer peripheral part for holding the sample at an outer peripheral part on a backside thereof and raising and lowering the sample;
a drive portion for raising and lowering the outer peripheral part;
an electrostatic chuck for attracting the backside of the sample; and
a part for correcting an electric field that is of substantially the same height as the peripheral portion of the sample when the sample is attracted onto the electrostatic chuck.

3. A sample holding system for holding a sample, comprising:
an electrostatic chuck for attracting the sample through an electrostatic force;
at least three outer peripheral parts disposed on an outer peripheral portion of the sample, the outer peripheral parts for holding the sample at an outer peripheral portion on a backside of the sample;
a vertical movement drive source for raising and lowering the outer peripheral parts;
a horizontal movement drive source for horizontally moving at least one of the outer peripheral parts;
a part for correcting an electric field disposed on the outer peripheral portion of the sample; and
a control unit for controlling vertical and horizontal movements of the outer peripheral parts; wherein
the electrostatic chuck includes cutouts for preventing the electrostatic chuck from interfering with the outer peripheral parts that move horizontally.

4. The sample holding system according to claim 3, wherein
the peripheral portion of the sample is substantially as high as the part for correcting an electric field when the sample is attracted onto the electrostatic chuck.

5. The sample holding system according to claim 3, wherein
a peripheral portion of the sample is substantially as high as the outer peripheral parts when the sample is attracted onto the electrostatic chuck.

6. The sample holding system according to claim 3, wherein
the part for correcting an electric field includes slits formed therein for preventing the part for correcting an electric field from interfering with the outer peripheral parts.
